(19) United States
(12) Patent Application Publication
(10) Pub. No.: US 2007/0146345 A1
(43) Pub. Date: Jun. 28, 2007

(54) PORTABLE ELECTRONIC DEVICE

(75) Inventor: Li Chieh Cheng, Taipei City (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/616,251

(22) Filed: Dec. 26, 2006

(30) Foreign Application Priority Data
Dec. 27, 2005 (TW) TW94146687

(51) Int. Cl. G09G 5/00

(52) U.S. Cl. 345/173

(57) ABSTRACT

A portable electronic device. The portable electronic device includes a body, an input module, a display device, and a solar charging system. The input module movably connects with the body and comprises an opening. The display device is disposed on the body. When the display device is partially covered by the input module, the display device is for displaying a first image through the opening, and when the display device is not covered by the input module, the display device is for displaying a second image. The solar charging system includes a solar panel, surrounding the opening, disposed on the input module on a side between the input module and the display device.

### BACKGROUND OF THE INVENTION

1. Field of the Invention

The invention relates to portable electronic devices, and in particular, to a portable electronic device comprising a foldable input module and a solar panel.

2. Description of the Related Art

Technology is in distinct progress nowadays, and communication product is commonly in use. Thus, a portable electronic device, such as a digital camera, becomes an important tool in our everyday life. Digital cameras currently provide lighter weight and thinner profile with large display to comply with trends toward miniaturization. However, as the size of the display approaches that of cameras, the camera body gets relatively small, a convenience for stable use. Additionally, cameras with large display monitors require high power consumption, such that a battery of the camera is exhausted rapidly.

### BRIEF SUMMARY OF THE INVENTION

The invention provides a portable electronic device with foldable input module, such that a suitable input module and a large display can be maintained without increasing the size of the device. Furthermore, the electronic device utilizes a solar panel to generate power, such that the electronic device can be charged during operation.

The invention provides a portable electronic device comprising a body, an input module, a display device, and a solar charging system. The input module movably connects with the body and comprises an opening. The display device is disposed on the body. When the display device is partially covered by the input module, the display device is for displaying a first image through the opening, and when the display device is not covered by the input module, the display device is for displaying a second image. The solar charging system comprises a solar panel, surrounding the opening. The solar panel is disposed on the input module on a side between the input module and the display device.

When the display device and the input module are partially covered by the input module, the solar panel is for absorbing at least part of light emitted from the display device to generate power for charging the electronic device.

When the display device and the input module is not covered by the input module, the solar panel is for absorbing ambient light to generate power for charging the electronic device.

The input module comprises a first key, disposed on a first surface of the input module and controlling the first image.

When the display device is partially covered by the input module, the electronic device is in operating mode.

The portable electronic further comprises a control module. The control module electrically couples to the display device, for detecting the relative position of the display device and the input module. The control module directs the display device to display the first image when the display device is covered by the input module.

The input module comprises a second key, disposed on a second surface of the input module and controlling the second image.

When the display device is not covered by the input module, the electronic device is in a review mode.

The portable electronic device further comprises a control module. The control module electrically couples to the display device, detecting the position of the display device and the input module. The control module directs the display device to display the second image when the display device is not covered by the input module.

The control module is electrically coupled to the input module. The control module disables the first key when the display device is not covered by the input module.

The solar panel is disposed on the second surface of the input module.

The portable electronic device further comprises a control module. The control module electrically couples to the display device, detecting position of the display device and the input module. The control module directs the display device to display the first image when the display device covers the input module.

The portable electronic device further comprises a control module, disposed in the body. The control module directs the display device to switch the first image to the second image when the display device is not covered by the input module.

The electronic device is a digital camera.

The invention provides another portable electronic device, comprising a body, an input module, and a display device. The input module pivotally connects with the body and comprises an opening. The input module moves relative to the body between a first position and a second position. The display device is disposed in the body. When the input module is in the first position, the input module covers a portion of the display device and the display device displays a first image through the opening. When the input module is in the second position, the display device displays a second image.

The portable electronic device further comprises a solar panel, surrounding the opening. The solar panel is disposed on the input module on a side between the input module and the display device when the input device is in the first position.

The input device comprises a first key and a second key. The first key is disposed on a first surface of the input module, controlling the first image, and the second key is disposed on a second surface of the input device, controlling the second image. The first surface is opposite to the second surface, and the second surface faces the display device when the input module is in the first position.

The input module comprises a first touch panel and a second touch panel. The first touch panel is disposed on a first surface of the input device, controlling the first image, and the second touch panel is disposed on a second surface of the input device, controlling the second image. The first surface is opposite to the second surface, and the second surface faces the display device when the input module is in the first position.

When the input module is in the first position, the electronic device is in operating mode, and the display device displays the first image through the opening. When the input module is in the second position, the electronic device is in a review mode, and the display device displays the second image.

The portable electronic device further comprises a control module, disposed in the body. The control module directs the display device to switch the first image to the second image when the input module is switched to the second position from the first position.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of a portable electronic device of the invention; and

FIG. 2 is another schematic view of the portable electronic device of the invention.

### DETAILED DESCRIPTION OF THE INVENTION

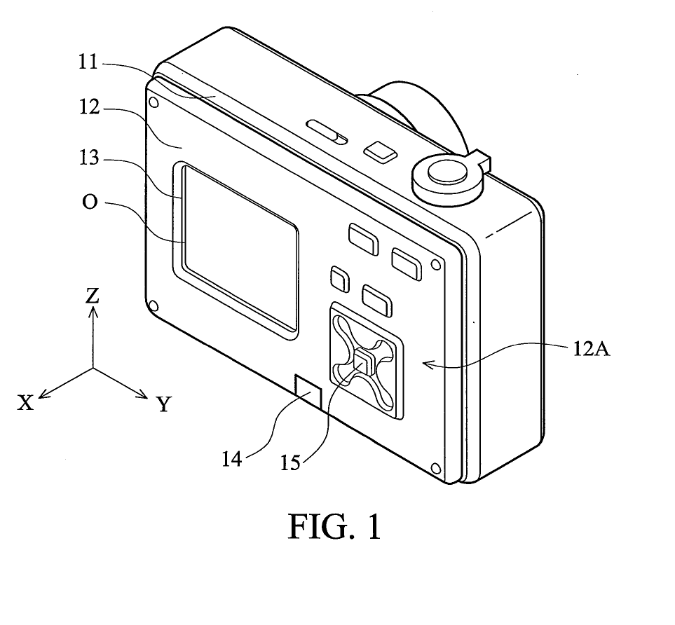

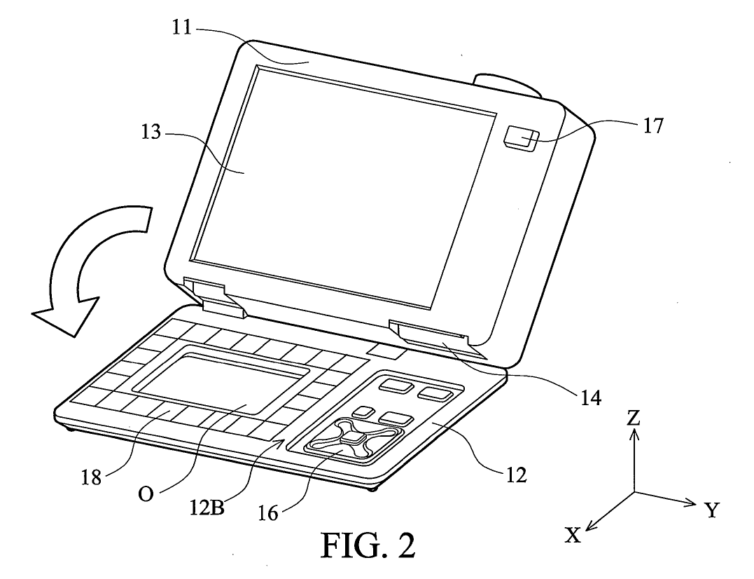

FIGS. 1 and 2 are schematic views of a portable electronic device of the invention. The portable electronic device in an exemplary embodiment of the invention is a digital camera, comprising a body 11, an input module 12, a display device 13, and a connecting device 14, a plurality of first keys 15, a plurality of second keys 16, a sensor 17, a control module (not shown), a solar charging system (not shown), and solar panels 18. The front surface of the body 11 comprises a lens and other basic members of a digital camera. The display device 13 is fixed on the back surface of the body 11. In this embodiment, the input module 12 pivotally connects with the body 11 by the connecting device 14, wherein the connecting device 12 is a hinge, although the assembly of the input module 12 is not limited thereto. For example, the body 11 can comprise a track, allowing the input module to connect with the body 11 in a sliding maimer. Further, the size of the input module 12 is substantially the same as the size of the body 11.

As shown in FIG. 1, the input module 12 and the display device 13 cover each other, in a closed position. At the time, the display device 13 displays a first image through an opening O of the input module 12. In this embodiment, the size of the first image is substantially the same as the size of the opening O. In addition, when the input module 12 and the display device 13 are in the closed position, the input module 12 is located in a first position as shown in FIG. 1, and the input module 12 covers a portion of the display device 13. Simultaneously, the plurality of first keys 15 is disposed on a first surface 12A of the input module 12, controlling the first image. When the input module 12 is in the first position, the first surface 12A of the input module 12 and the display device 13 face the same direction (direction X), and a second surface 12B, opposite to the first surface 12A, faces the display device 13.

As shown in FIG. 2, the input module 12 moves relative to the display device 13 to an open position. At the time, the display device 13 displays a second image. In this embodiment, the size of the second image is substantially the same as the size of the display device 13. When the input module 12 and the display device 13 are in the open position, the input module 12 is in a second position as shown in FIG. 2, and the input module 12 is completely unfolded to expose the display device 13. The plurality of second keys 16 are disposed on the second surface 12B of the input module 12, controlling a second image. In this embodiment, the input module 12 pivotally connects with the body, such that the second surface 12B of the input module 12 and the display device 13 face different directions when the input module 12 is in the second position, but it is not limited thereto.

The control module is disposed in the body 11, electrically coupled to the display device 13, controlling the size of the display images (the first and second images). The control module comprises a sensor 17, disposed on the body 11. When the input module 12 and the display device 13 are in the closed position, the input module 12 completely covers or contacts the sensor 17. When the input module 12 and the display device 13 are in open position, the sensor 17 is exposed without contacting the input module 12. In other words, the control module detects movement of the input module 12 (from the first position to the second position) by the sensor 17. The control module directs the display device 13 to switch the first image to the second image. The sensor 17 can for examples, be a light sensor, a piezoelectric sensor, or a magnetic sensor. The control module can further electrically couple to the input module 12, controlling action of the first keys 15 and the second keys 16. When the control module detects that the display device 13 and the input module 12 are in the open position, the control module sends signals to the first keys 15, temporarily locking the first keys 15, avoiding accidental activation of the first keys 15.

The solar charging system is disposed in the body 11, allowing the electronic device to be charged thereby. The solar charging system comprises solar panels 18, disposed on the second surface 12B of the input module 12, and surrounding the opening O. When the input module 12 is in the closed position (the first position), disposed between the input module 12 and the display device 13, such that the solar panel generates power from partial light, retained by the input module 12, of the display device 13, converting light energy to electrical energy, charging the battery (not shown) of the electronic device.

In FIG. 1, the electronic device is in the operating mode, i.e. filming mode. The display device 13 displays a first image through the opening O of the input module 12. For example, the display device 13 displays the image of the filmed object for user's preview. The solar panel absorbs the light emitted from the display device 13 and retained by the input module 12, converts light energy to electrical energy, and charges the battery of the electronic device.

Because the input module 12 covers a large portion of the display device 13, the first image displayed by the display device 13 is smaller than display area of the display device 13.

The input module 12 and the display device 13 are relatively unfolded as shown in FIG. 2. The sensor 17 senses that the input module 12 rotates from the first position to the second position, such that the first image of the display device 13 is switched to the second image thereby. That is, the electronic device is switched to review mode from operating mode. The second image of the display device 13 is displayed in a full screen. The solar panels 18 are further exposed, and ambient light can be absorbed and converted to electrical energy, charging the battery of the electronic device.

In addition, the input module 12 comprises a first touch panel and a second touch panel. The first touch panel is disposed on the fist surface 12A of the input module 12, controlling the first image. The second touch panel is disposed on the second surface 12B of the input module 12, controlling the second image.

The portable electronic device disclosed utilizes foldable and rotatable input module, such that an appropriate input module and a large display screen do not increase the size of the electronic device. Furthermore, in both operating mode or review mode, the electronic device is charged by the solar panel, enhancing operating convenience.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A portable electronic device, comprising:
a body;
an input module movably connected with the body, comprising an opening;
a display device, disposed on the body, wherein when the display device is partially covered by the input module, the display device is for displaying a first image through the opening, and when the display device is not covered by the input module, the display device is for displaying a second image; and
a solar charging system comprising a solar panel, surrounding the opening, disposed on the input module on a side between the input module and the display device.

2. The portable electronic device as claimed in claim 1, wherein when the display device is partially covered by the input module, the solar panel is for absorbing at least part of light emitted from the display device to generate power for charging the electronic device.

3. The portable electronic device as claimed in claim 2, wherein when the display device is not covered by the input module, the solar panel is for absorbing ambient light to generate power for charging the electronic device.

4. The portable electronic device as claimed in claim 1, wherein the input module comprises a first key, disposed on a first surface of the input module, and controlling the first image.

5. The portable electronic device as claimed in claim 4, wherein when the display device is partially covered by the input module, the electronic device is in operating mode.

6. The portable electronic device as claimed in claim 5, further comprising a control module, electrically coupled to the display device, for detecting the relative position of the display device and the input module, and the control module directs the display device to display the first image when the display device is covered by the input module.

7. The portable electronic device as claimed in claim 4, wherein the input module comprises a second key, disposed on a second surface of the input module, and controlling the second image.

8. The portable electronic device as claimed in claim 5, wherein when the display device is not covered by the input module, the electronic device is in a review mode.

9. The portable electronic device as claimed in claim 8, further comprising a control module, electrically coupled to the display device, detecting the positions of the display device and the input module, and the control module directs the display device to display the second image when the display device is not covered by the input module.

10. The portable electronic device as claimed in claim 9, wherein the control module is electrically coupled to the input module, and the control module disables the first key when the display device is not covered by the input module.

11. The portable electronic device as claimed in claim 8, wherein the solar panel is disposed on the second surface of the input module.

12. The portable electronic device as claimed in claim 1, wherein the input module comprises a first touch panel and a second touch panel, the first touch panel disposed on a first surface of the input module, controlling the first image, and the second touch panel disposed on a second surface of the input device, controlling the second image; wherein the first surface is opposite to the second surface, and the solar panel is disposed on the second surface and the second surface faces the display device when the input module covers the display device.

13. The portable electronic device as claimed in claim 1, further comprising a control module disposed in the body, wherein the control module directs the display device to switch the first image to the second image when the display device is not covered by the input module.

14. The portable electronic device as claimed in claim 1, wherein the electronic device is a digital camera.

15. A portable electronic device, comprising:
a body;
an input module pivotally connected with the body, comprising an opening, wherein the input module moves relative to the body between a first position and a second position; and
a display device, disposed on the body, wherein when the input module is in the first position, the input module partially covers the display device and the display device is for displaying a first image through the opening; and when the input module is in the second position, the display device is for displaying a second image.

16. The portable electronic device as claimed in claim 15, further comprising a solar panel, surrounding the opening, is disposed on the input module on a side between the input module and the display device when the input device is in the first position.

17. The portable electronic device as claimed in claim 15, wherein the input device comprises a first key and a second key, the first key is disposed on a first surface of the input module, controlling the first image; the second key is disposed on a second surface of the input device, controlling the second image; the first surface is opposite the second surface, and the second surface faces the display device when the input module is in the first position.

18. The portable electronic device as claimed in claim 15, wherein the input module comprises a first touch panel and a second touch panel, the first touch panel is disposed on a first surface of the input device, controlling the first image, and the second touch panel is disposed on a second surface of the input device, controlling the second image; the first surface is opposite to the second surface, and the second surface faces the display device when the input module is in the first position.

19. The portable electronic device as claimed in claim 15, wherein when the input module is in the first position, the electronic device is in an operating mode, and the display device displays the first image through the opening; when the input module is in the second position, the electronic device is in a review mode, and the display device displays the second image.

20. The portable electronic device as claimed in claim 15, further comprising a control module, disposed in the body, wherein the control module directs the display device to switch the first image to the second image when the input module is switched to the second position from the first position.
